(19) United States
(12) Patent Application Publication
(10) Pub. No.: US 2024/0300044 A1
(43) Pub. Date: Sep. 12, 2024

(54) VARIABLE HELICAL COMPOSITE TAP

(71) Applicant: Danyang Renyu Hardware Products Co., LTD, Zhenjiang (CN)

(72) Inventor: Juhua Zhu, Zhenjiang (CN)

(21) Appl. No.: 18/582,330

(22) Filed: Feb. 20, 2024

(30) Foreign Application Priority Data
Mar. 10, 2023 (CN) 202320440588.7

(51) Int. Cl. B23G 5/20

(52) U.S. Cl. CPC B23G 5/20; B23G 2200/143; B23G 2200/146; B23G 2200/40; B23G 2200/48

(57) ABSTRACT

The present disclosure provides a variable helical composite tap, which includes a drill bit segment and a tap segment sequentially arranged, where a helical angle of the drill bit segment is greater than a helical angle of the tap segment, and a core thickness of the tap segment is greater than a core thickness of the drill bit segment. The helical angle of the drill bit segment from a drill tip to a connection end of the tap segment with the drill bit segment increases continuously. The helical angle of the tap segment from the drill tip to a drill handle increases continuously, and preferably, the core thickness from the drill tip to the drill handle increases continuously. Compared with the prior arts, the drill bit segment of the present disclosure has a greater helical angle and a better chips removal effect is produced in the drill bit.

### CROSS-REFERENCE TO RELATED APPLICATION

This application claims priority from the Chinese patent application 2023204405887 filed Mar. 10, 2023, the content of which is incorporated herein in the entirety by reference.

### TECHNICAL FIELD

The present disclosure relates the field of cutting tool technologies and in particular to a variable helical composite tap.

### BACKGROUND

The variable helical composite taps can perform drilling and tapping operations at the same time, greatly increasing the processing efficiency. In consideration of separate drill bit and tap, the helical angle of the drill bit should be greater than the helical angle of the tap. This is because more consideration is to be given to the chips removable problem for the drill bit than for the tap. For this problem, the patent with the publication number “CN108971671B” in the prior arts disclosed a helical-groove tap with a continuously-increasing helical angle, which can meet the processing requirements of the tap and drilling chips.

On the other hand, the variable helical composite taps usually have a larger length due to its simultaneous drilling and tapping functions. Further, it has to bear the torques of the drilling and tapping at the same time during operation, thus a higher strength is required to ensure its working reliability and service life.

### SUMMARY

In order to overcome the defects in the prior arts, the present disclosure provides a variable helical composite tap.

In order to achieve the above object, the present disclosure employs the following technical solution.

The variable helical composite tap includes a drill bit segment and a tap segment sequentially arranged. A helical angle of the drill bit segment is greater than a helical angle of the tap segment, and a core thickness of the tap segment is greater than a core thickness of the drill bit segment.

Preferably, in the above variable helical composite tap, the helical angle of the drill bit segment from a drill tip to a connection end of the tap segment with the drill bit segment increases continuously.

Preferably, in the above variable helical composite tap, the helical angle of the tap segment from the drill tip to a drill handle increases continuously.

Preferably, in the above variable helical composite tap, the core thickness from the drill tip to the drill handle increases continuously.

Preferably, in the above variable helical composite tap, the number of helical grooves is 2 to 4.

The present disclosure has the following beneficial effects: compared with the prior arts, the drill bit segment of the present disclosure has a greater helical angle and a better chips removal effect is produced in the drill bit. Furthermore, the primary chips-cutting blade is sharper and hence reduces the cutting resistance and increases the chips removal effect.

Moreover, the continuous increase of the core thickness from the drill tip to the drill handle in the present disclosure can increase the bearing torque of the entire composite tap.

### BRIEF DESCRIPTIONS OF THE DRAWINGS

FIG. 1 is a front view of an entire structure of the present disclosure.

The numerals of the drawing are described below: 1. drill bit segment, 2. tap segment, A. helical angle, and B. core thickness.

### DETAILED DESCRIPTIONS OF EMBODIMENTS

The present disclosure will be further described below in combination with drawings. The following embodiments are used only to more clearly describe the technical solution of the present disclosure rather than to limit the scope of protection of the present disclosure.

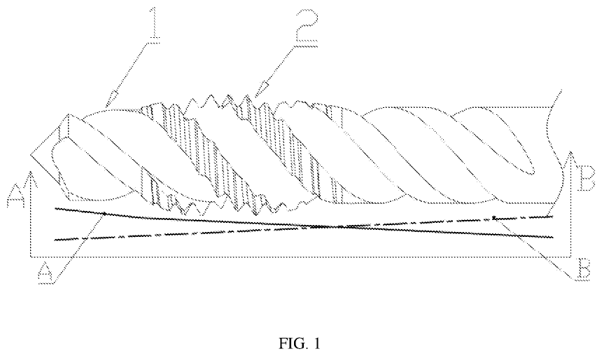

As shown in FIG. 1, the present embodiment provides a variable helical composite tap, which includes: a drill bit segment 1 and a tap segment 2 sequentially arranged. In FIG. 1, A represents a helical angle, and B represents a core thickness. The helical angle of the drill bit segment 1 is greater than the helical angle of the tap segment 2, and the core thickness of the tap segment 2 is greater than a core thickness of the drill bit segment 1. The helical angle of the drill bit segment 1 from a drill tip to a connection end of the tap segment 2 with the drill bit segment (from left to right in the front view of FIG. 1) increases continuously. The helical angle of the tap segment 2 from the drill tip to a drill handle (from left to right in the front view 1) increases continuously.

As a result, the drill bit segment 1 has a greater helical angle and a better chips removal effect is produced in the drill bit. Further, the primary chips-cutting blade is sharper and hence reduces the cutting resistance and increases the chips removal effect. Further, the tap segment 2 with a smaller helical angle will not be affected. Actually, from the angle of tapping processing, the size of the helical angle of the tap does not affect the tapping progress, which can be seen from the straight tap in the prior arts.

Furthermore, the continuous increase of the core thickness from the drill tip to the drill handle in the present embodiment increases the bearing torque of the entire composite tap.

The above are preferred embodiments of the present disclosure. It should be pointed out that those skilled in the arts can also make several improvements and variations without departing from the technical principle of the present disclosure, and these improvements and variations are all considered to be within the scope of protection of the present disclosure.

1. A variable helical composite tap, comprising a drill bit segment (1) and a tap segment (2) sequentially arranged, wherein a helical angle of the drill bit segment (1) is greater than a helical angle of the tap segment (2), and a core thickness of the tap segment (2) is greater than a core thickness of the drill bit segment (1).

2. The variable helical composite tap of claim 1, wherein the helical angle of the drill bit segment (1) from a drill tip to a connection end of the tap segment (2) with the drill bit segment increases continuously.

3. The variable helical composite tap of claim 1, wherein the helical angle of the tap segment (2) from the drill tip to a drill handle increases continuously.

4. The variable helical composite tap of claim 1, wherein the core thickness from the drill tip to the drill handle increases continuously.

5. The variable helical composite tap of claim 1, wherein the number of helical grooves is 2 to 4.

6. The variable helical composite tap of claim 2, wherein the helical angle of the tap segment (2) from the drill tip to a drill handle increases continuously.
